(19) United States
(12) Patent Application Publication
(10) Pub. No.: US 2008/0296107 A1
(43) Pub. Date: Dec. 4, 2008

(54) Parking brake actuator with spring force provided by flexible actuator cable

(76) Inventors: Steven R. Porter, Bumsville, MN (US); Brandon N. Imsdahl, St. Paul, MN (US)

Correspondence Address: JAMES W. MILLER, ATTORNEY, 527 MARQUETTE AVENUE, SUITE 1960, RAND TOWER, MINNEAPOLIS, MN, 55402, US

(21) Appl. No.: 11/807,480

(22) Filed: May 29, 2007

(51) Int. Cl. F16D 65/30

(52) U.S. Cl. 188/2 D

(57) ABSTRACT

This invention relates to a pivotal control for engaging and disengaging the parking brake of an outdoor power equipment unit such as a lawn mower. The control is laterally pivotal from an inboard to an outboard position by the operator as the operator mounts or dismounts the unit. This lateral pivoting motion is converted by a bevel gear arrangement to a longitudinal push on the inner cable of a Bowden cable, with the inner cable being connected to a parking brake. Pushing on the inner cable in this manner causes a portion of the inner cable between a fixed rear end of the outer sheath of the Bowden cable and the parking brake to become additionally curved or bowed. The amount of this additional curvature or bow is sufficient to develop a biasing force in the inner cable that keeps the parking brake engaged. Thus, no separate biasing spring is required.

### TECHNICAL FIELD

This invention relates to an outdoor power equipment unit, such as a lawn mower, having a parking brake actuated by a pivotal control. More particularly, this invention relates to the use of a flexible actuator cable to link the control to the parking brake to actuate the parking brake upon pivotal movement of the control.

### BACKGROUND OF THE INVENTION

When operating an outdoor power equipment unit such as a riding lawn mower, the operator frequently needs to dismount the unit. Most units of this type have a parking brake to prevent the unit from rolling away when the operator dismounts. A manually operated brake lever is usually provided to engage and disengage the parking brake. If the operator forgets to set or engage the parking brake as the operator dismounts, the unit can roll away if the unit is located on an incline when the operator dismounts. This is obviously undesirable.

Similarly, the operator must also remember to disengage the parking brake when he remounts the unit to continue operating the unit. If the operator does not do so and the parking brake remains engaged, there is a potential for damaging the parking brake or drive train of the unit. At the very least, the parking brake and drive train experience undue wear if the unit is driven while the parking brake remains engaged. Thus, the operator must pay careful attention to the parking brake to make sure it is engaged when he dismounts and is disengaged after he remounts before he commences operation of the unit.

Various riding lawn mowers are controlled by twin control sticks or handles that are selectively manipulated by the operator to propel and steer the unit. The control sticks have a neutral position in which the unit is at rest. To propel the unit forwardly, the sticks are pushed forwardly by the operator from the neutral position. To propel the unit rearwardly, the sticks are pulled rearwardly by the operator from the neutral position. Steering is accomplished by pushing or pulling on one stick more than the other or even by pushing one stick forwardly while pulling the other stick rearwardly. U.S. Pat. No. 3,702,051 to Deines shows a mower of this type.

The twin control sticks of units of this type have an inboard position in front of the operator's seat where they are conveniently located in front of the operator's hands. However, in this position, the operator cannot easily reach the seat for mounting and dismounting as the control sticks obstruct access to the seat. Thus, such control sticks are also pivotal about longitudinal, fore-and-aft axes to allow the sticks to be pivoted laterally into outboard positions. In their outboard positions, the control sticks do not obstruct the operator's access to the seat.

Accordingly, to dismount the unit, a seated operator first pivots the control sticks laterally into their outboard positions to clear the way for dismounting. To remount the unit, the operator first climbs back onto the seat by passing between the control sticks when such control sticks are disposed in their outboard positions. After the operator is reseated, the operator can then pivot the control sticks from their outboard positions back into their inboard positions until the control sticks are located generally in front of the operator as the operator sits on the seat. The fact that the control sticks in a twin stick unit of this type laterally pivot between inboard and outboard positions to allow mounting and dismounting is well known in the mower art.

U.S. Pat. No. 6,434,917 to Bartel shows a twin stick mower in which the control sticks are linked by mechanical linkages to a parking brake comprising a pair of parking brakes, one for each drive train controlled by each control stick. In Bartel, the mechanical linkages are elongated and extend vertically to connect between the parking brakes and the control sticks. Moreover, the linkages include ball joints to accommodate the lateral pivoting of the control sticks when the control sticks are placed in their outboard positions. Thus, the mechanical linkages are relatively cumbersome and are located in an area of the mower where space is tight.

The Toro Company, the assignee of this invention, has built and sold a mower, such as the TimeCutter Z380, that is similar to the mower disclosed in the 917 patent, namely a mower having twin control sticks that engage parking brakes when the control sticks are laterally pivoted to outboard positions. In this prior art Toro mower, the control sticks pivot about two orthogonal pivot axes rather than using ball joints. An actuator carries each control stick with the actuator pivoting on the frame of the mower about a transverse, lateral pivot axis. This allows the control stick to be longitudinally pushed forwardly or pulled rearwardly to longitudinally pivot the control stick to propel the mower forwardly or rearwardly. In addition, the control stick further pivots on the actuator itself about a longitudinal, fore and aft pivot axis to allow the control stick to be swung or pivoted laterally between the inboard and outboard positions thereof. This lateral pivoting of the control stick on the actuator is what engages or disengages the parking brake.

In this prior art Toro mower noted above, the control stick is connected by a fairly complicated mechanical linkage to the parking brake. The lateral pivoting of the control stick has to be converted to a longitudinal motion of a connecting rod. The connecting rod extends rearwardly from the control stick to the parking brake. Rearwardly moving or sliding the connecting rod when the control stick pivots laterally outwardly engages the parking brake.

In this prior art Toro mower, this motion conversion is done by three distinct components: a first link carried on the control stick, a vertical connector that gets lifted when the first link is pivoted by laterally outward motion of the control stick, and a bell crank that pivots on a lateral pivot axis. One arm of the bell crank is connected to the vertical connector so that the bell crank gets rotated about the lateral pivot axis when the vertical connector is lifted. The other arm of the bell crank is connected to the front end of the connecting rod to push rearwardly on the connecting rod when the bell crank is pivoted. Thus, three separate parts and the space needed to accommodate such parts are required, namely the first link, the vertical connector, and the bell crank, just to translate the laterally outward pivoting of the control stick to a rearward push on the connecting rod that leads to the parking brake. This is in addition to the rearwardly extending connecting rod itself, which comprises a fourth part.

In addition, the parking brake must be positively engaged when the parking brake is actuated by the connecting rod. In the existing Toro mower design described above, this is done using a spring surrounding a portion of the rearwardly extending connecting rod. The spring supplies a positive biasing force that keeps the parking brake engaged when the control stick has been pivoted laterally outwardly. Thus, the spring comprises yet another component or part, i.e. a fifth part, in this prior art design. The need for this number of components obviously increases the cost and complexity of the mower. A simpler and more cost effective design is desirable.

### SUMMARY OF THE INVENTION

One aspect of this invention relates to an outdoor power equipment unit which comprises a frame supported for movement over the ground by a plurality of wheels. At least one wheel is a drive wheel to propel the frame over the ground. An implement is carried on the frame for performing a ground or turf grooming or working operation. A parking brake is provided. A control is selectively movable by an operator of the unit for engaging and disengaging the parking brake. The control is operatively coupled to the parking brake by a flexible actuator cable. The actuator cable is arranged relative to the control and to the parking brake such that a portion of the actuator cable becomes additionally curved or bowed when the control is moved to engage the parking brake with the additional curvature or bow in the actuator cable being sufficient to exert a biasing force on the parking brake tending to keep the parking brake engaged.

Another aspect of this invention relates to an outdoor power equipment unit which comprises a frame supported for movement over the ground by a plurality of wheels. At least one wheel is a drive wheel to propel the frame over the ground. An implement is carried on the frame for performing a ground or turf grooming or working operation. A parking brake is provided. A control is selectively movable by an operator of the unit for engaging and disengaging the parking brake. The control is pivotally carried on the frame of the unit for lateral movement relative to the unit between an inboard position located in front of an operator's seat and an outboard position located to one side of the operator's seat to permit the operator to mount and dismount the unit. A linkage couples the control to the parking brake. A bevel gear arrangement converts laterally outward pivoting of the control between the inboard and outboard positions thereof into longitudinal movement of at least a portion of the linkage relative to the frame to engage the parking brake.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a perspective view of an outdoor power equipment unit equipped with a control according to this invention for actuating a parking brake;

FIG. 2 is an enlarged perspective view of a portion of the unit of FIG. 1, particularly showing the control and the cable linkage leading from the control to the parking brake;

FIG. 3 is a side elevational view of a portion of the unit of FIG. 1, particularly showing a portion of the cable linkage used to actuate the parking brake and the connection of such linkage to the parking brake;

FIG. 4 is a side elevational view of a portion of the unit of FIG. 1, particularly showing a portion of the cable linkage used to actuate the parking brake and the connection of such linkage to the control; and

FIG. 5 is a side elevational view of a portion of the unit of FIG. 1, particularly showing the lower end of the control and the bevel gear used to convert the laterally outward pivoting motion of the control to a longitudinal actuation of the cable linkage.

### DETAILED DESCRIPTION

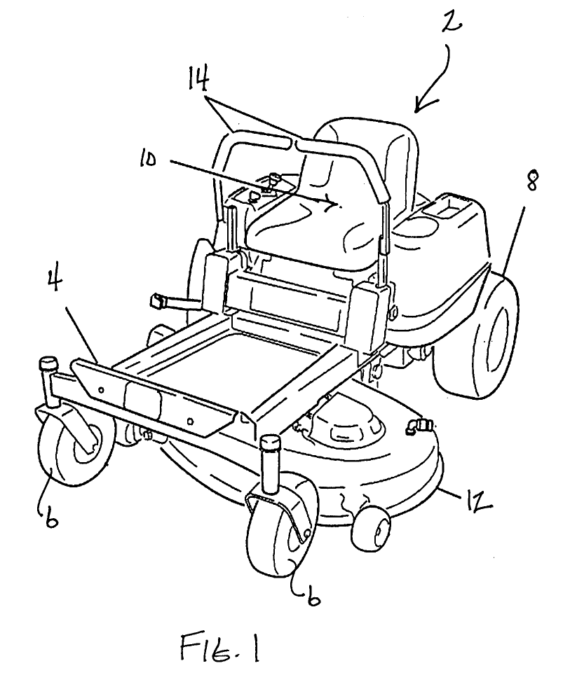

FIG. 1 illustrates an outdoor power equipment unit 2 comprising a riding mower. Unit 2 includes a frame 4 supported for movement over the ground by a pair of front caster wheels 6 and a pair of rear drive Wheels 8. A seat 10 is provided on frame 4 for supporting a seated operator. An internal combustion engine or the like (not shown) is provided on the rear of frame 4 behind seat 10 to power unit 2. A cutting deck 12 is mounted underneath frame 4 between front caster wheels 6 and rear drive wheels 8 for mowing grass or the like.

Unit 2 includes two control sticks 14 for allowing the operator to cause unit 2 to move in forward and reverse and to steer unit 2. Each control stick 14 controls an independent hydrostatic transmission or transaxle 16 that drives one of the rear drive wheels 8 in a known manner. The internal combustion engine powers each transaxle 16 as well as cutting deck 12. Each transaxle 16 can be operated separately from the other and at different speeds by its corresponding control stick 14 to achieve both propulsion and steering of unit 2.

As shown in FIG. 1, each control stick 14 has an inboard position in which the top of control stick 14 is located in front of the operator as the operator sits on seat 10. Each control stick 14 also has a laterally pivoted, outboard position in which control stick 14 has been pivoted to one side largely out of the way of seat 10 to permit the operator to more easily mount and dismount seat 10. Normally, both control sticks 14 are usually disposed in the same position, i.e. both control, sticks 14 are either in their inboard positions or in their laterally pivoted, outboard positions at the same time, though it is physically possible to have one stick 14 in one position and the other stick 14 in the other position.

Unit 2 also includes a parking brake system 18 for preventing unit 2 from rolling when it is parked. Because unit 2 includes two independent transaxles 16 for powering the two drive wheels 8, parking brake system 18 includes two independent parking brakes 20, one for each transaxle 16. Parking brakes 20 are in the form of toothed pawls.

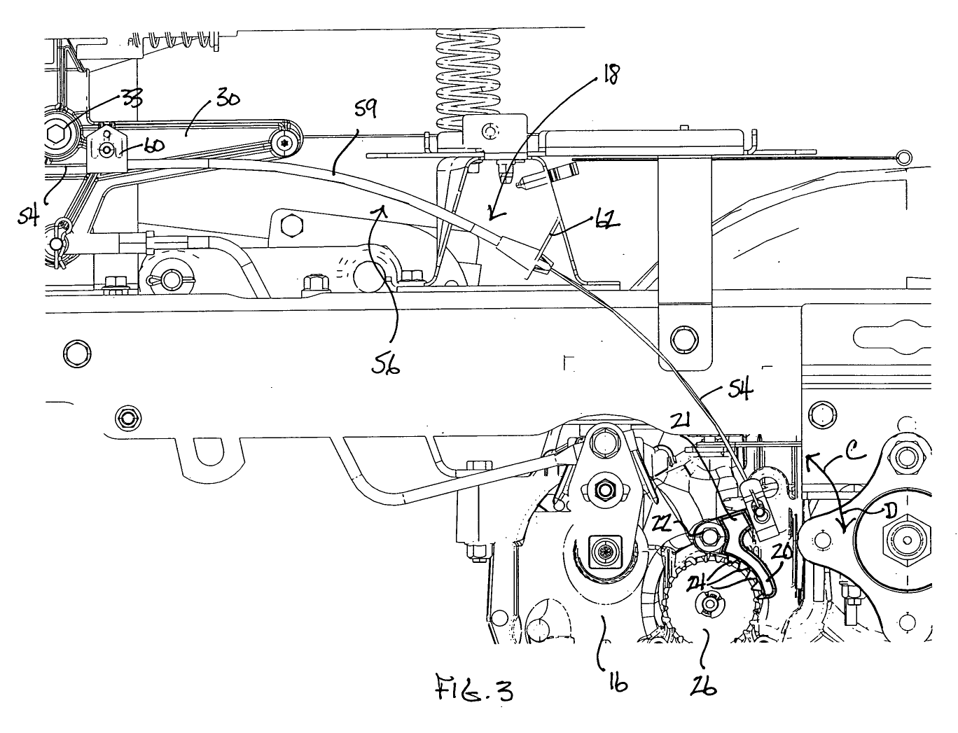

Referring now to FIG. 3, each parking brake 20 is pivotally mounted on the housing of a transaxle 16 by a pivot pin 22. Each parking brake 20 has teeth 24 for meshing with an external gear or sprocket 26 of transaxle 16. When the parking brake 20 is pivoted into meshing engagement with gear 26 as shown in FIG. 3, transaxle 16 is locked up to prevent transaxle 16 from rotating to thereby lock the corresponding drive wheel 8. When the parking brake 20 is pivoted out of meshing engagement with gear 26, transaxle 16 and its associated drive wheel 8 are both free to rotate.

While the use of a parking brake system 18 comprising two independent parking brakes 20 has been illustrated, it would be possible to have a parking brake system 18 which deletes one of the two parking brakes 20. Locking up a single transaxle 16 and its associated drive wheel 8 should be sufficient to prevent unit 2 from rolling. However, it is preferred to use dual parking brakes 20 when dual independent transaxles 16 are used. Thus, the number of parking brakes 20 within parking brake system 18 can obviously be varied as long as there is at least one such parking brake 20.

In addition, parking brakes 20 that are mechanically different from pivotal pawl type parking brakes engaging a gear on a transaxle could also be used. This is particularly true where the drive wheels 8 are driven by some type of drive system other than that shown herein. Thus, the nature of the parking brake(s) used within parking brake system 18 can also be varied. The phrase “parking brake system” as used herein is simply meant to apply to any system that has at least one parking brake for holding unit 2 stationary when it is parked with such parking brake having both an engaged and disengaged position.

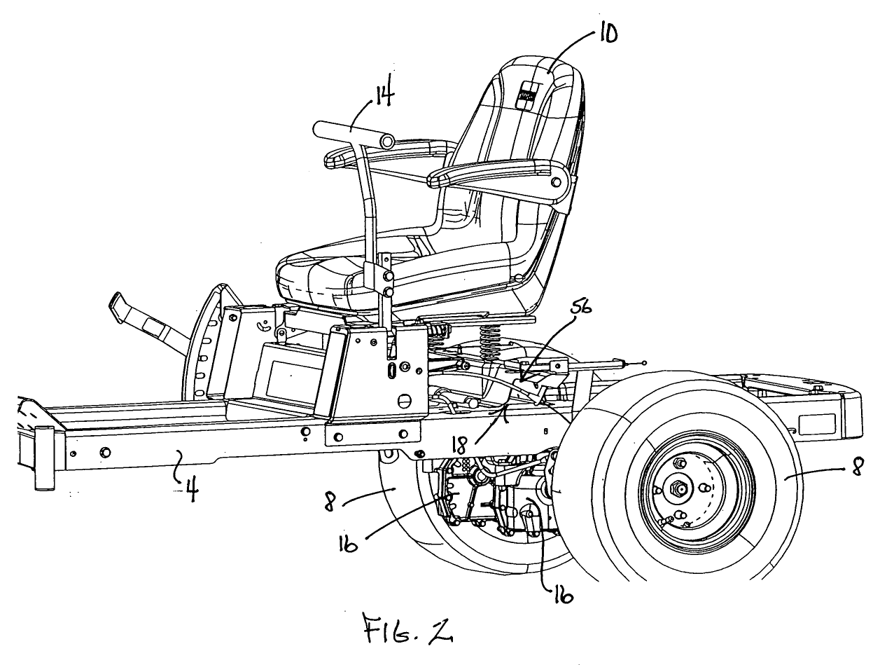

Each parking brake 20 is engaged and disengaged by one control stick 14. The linkage that does this is identical for each control stick 14 and its corresponding parking brake 20. Thus, the linkage extending between only one control stick 14 and its corresponding parking brake 20 need be specifically described. That linkage will now be described in conjunction with FIGS. 2-5.

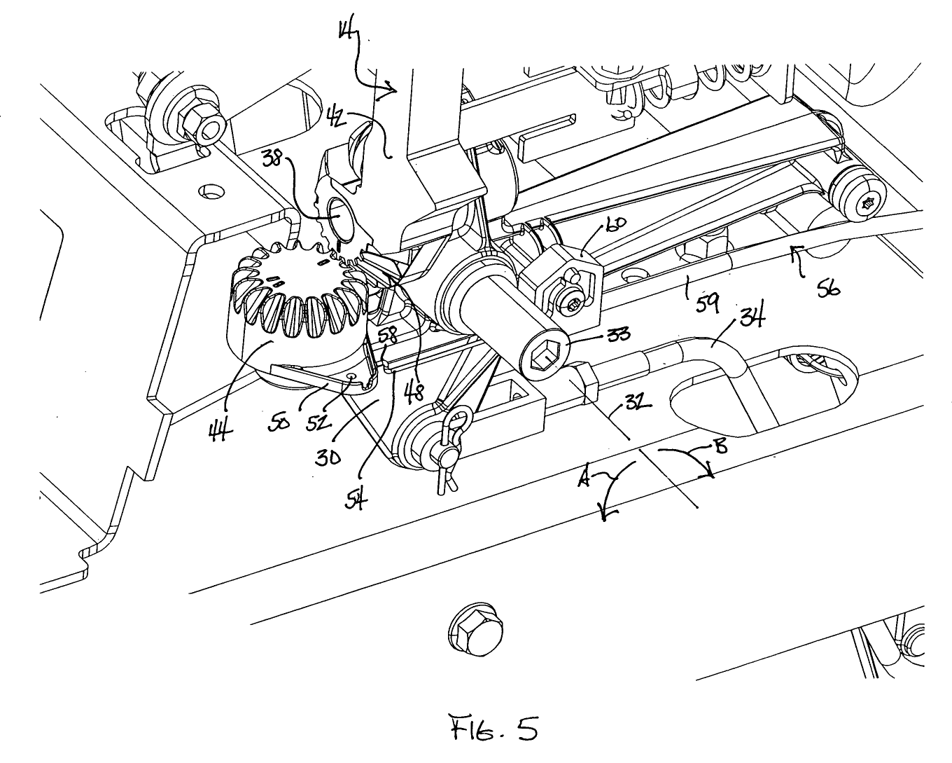

A pivotal actuator 30 is carried on frame 4 of unit 2 for pivotal movement about a lateral pivot axis 32 formed by pivot pin 33. Control stick 14 is carried with and supported by pivotal actuator 30. Thus, as the operator pushes forwardly on control stick 14 to cause forward motion of unit 2, control stick 14 pivots forwardly about lateral pivot axis 32 as indicated by the arrow A in FIG. 5. Conversely, if the operator pulls rearwardly on control stick 14 to cause reverse motion of unit 2, control stick 14 pivots rearwardly about lateral pivot axis 32 as indicated by the arrow B in FIG. 5. Forward and reverse motion is accomplished since the bottom of actuator 30 is linked by a mechanical connecting rod 34 to a direction and speed change mechanism on the hydrostatic transmission 16 that drives rear wheel 8 on the corresponding side of unit 2.

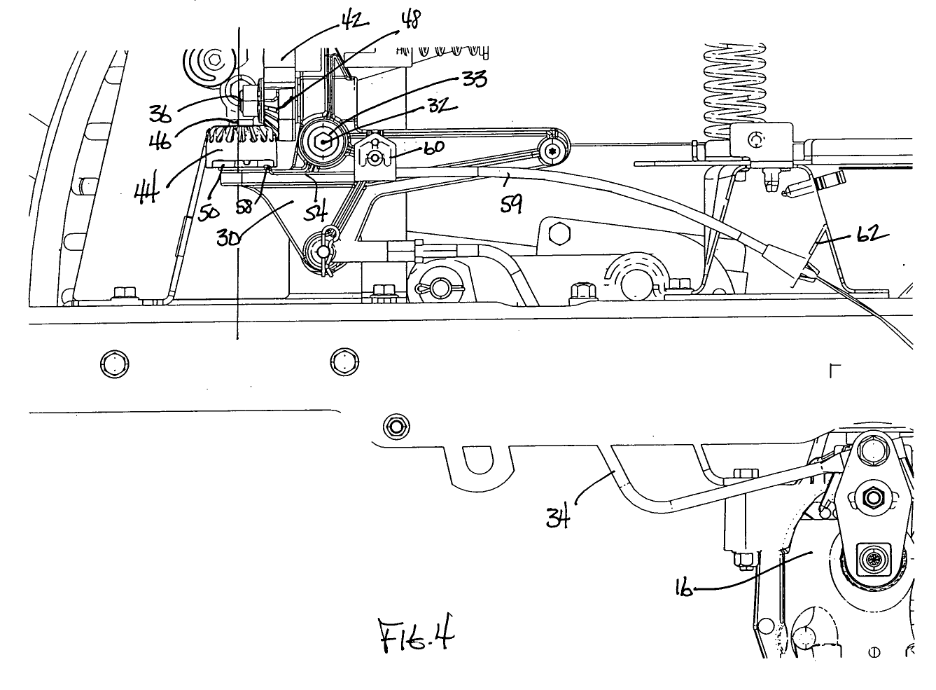

While control stick 14 moves with actuator 30 for longitudinal pivoting motion in the direction of the arrows A and B in FIG. 2, control stick 14 is also independently mounted on actuator 30 for lateral pivoting motion of control stick 14 relative to actuator 30. Thus, the lower end 42 of each control stick has a bore 38 that is pivotally journalled on a longitudinal pivot pin 36 defining a longitudinal pivot axis. Pivot pin 36 has been removed in FIG. 5 to better illustrate bore 38, but pivot pin 36 is shown in FIG. 4 passing through lower end 42 of control stick 14. Thus, because of longitudinal pivot pin 36, control stick 14 is enabled to laterally pivot between the inboard and outboard positions thereof as described above.

Actuator 30 also carries a bevel gear 44 that is mounted for rotation on a vertical pivot axis 46. Bevel gear 44 is placed immediately forward of lower end 42 of control stick 14. The teeth of bevel gear 44 are in engagement with teeth on a mating sector gear 48 that is formed as an integral part of lower end 42 of control stick 14. Because control stick 14 has only a limited angular range through which it laterally pivots, sector gear 48 on lower end 42 of control stick 14 extends only along an arcuate portion of a circle and is not a full 360° gear. When control stick 14 is pivoted laterally outwardly about the longitudinal pivot axis, the engagement of sector gear 48 and bevel gear 44 causes bevel gear 44 to rotate a similar angular amount about its vertical pivot axis.

Bevel gear 44 has a laterally extending, horizontal attachment ear 50. Ear 50 contains an attachment hole 52 at its outer end thereof. Hole 52 is sized to allow an inner cable 54 of a flexible Bowden cable 56 to be connected thereto. The front end of inner cable 54 of Bowden cable 56 has a hook configuration 58 allowing the front end of inner cable 54 to be slipped up into and retained in hole 52 on the ear 50 of bevel gear 44. Hook 58 is shown in FIGS. 4 and 5 as being disconnected from hole 42 for the purpose of clarity. When bevel gear 44 rotates by virtue of the lateral pivoting motion of control stick 14, inner cable 54 is longitudinally pulled or pushed depending upon the direction of rotation of bevel gear 44.

As is typical in Bowden cables 56, inner cable 54 slides within an outer sheath 59. Outer sheath 59 is clamped to various portions of unit 2. The front end of outer sheath 59 is clamped by a bracket 60 to pivotal actuator 30 just rearwardly of lateral pivot axis 32. See FIGS. 3-5. The rear end of outer sheath 59 is clamped to a bracket 62 that is part of frame 4 of unit 2. See FIGS. 3 and 4.

Referring to FIG. 3, the rear end of inner cable 54 extends for some distance out of outer sheath 59 and connects to parking brake 20. When inner cable 54 is slid forwardly from the orientation shown in FIG. 3, it lifts on a rearwardly extending arm 21 of parking brake 20 to pivot parking brake 20 in the direction of the arrow C about pivot pin 22. This will pivot parking brake 20 out of engagement with gear 26 to release parking brake 20. Inner cable 54 is slid forwardly in this manner when control stick 14 is disposed in its laterally inboard position.

However, when the operator pivots control stick 14 to its laterally outboard position to clear the space in front of the operator's seat to allow the operator to dismount, bevel gear 44 is rotated in a direction that pushes rearwardly on the front end of inner cable 54. As the front end of inner cable 54 is pushed rearwardly, the rear portion of inner cable 54 gets pushed further out of the fixed rear end of outer sheath 59 which is clamped to bracket 62. In other words a larger length of inner cable has to be accommodated in the space between parking brake 20 and the spatially fixed bracket 62.

This motion of the rear portion of inner cable 54 does two things. First, it pushes down on arm 21 of parking brake 20 to pivot parking brake 20 into its engaged position as shown by the arrow D in FIG. 3. In this position as shown in FIG. 2, the teeth 24 of parking brake 20 mesh with gear 26. In addition, inner cable 54 of Bowden cable 56 is forced to bend or become more curved in order to accommodate the additional length of wire between parking brake 20 and the rear end of outer sheath 59. In fact, this bend is designed to be large enough so that inner cable 54 of Bowden cable 56 actually develops a biasing force on parking brake 20 tending to keep parking brake 20 engaged. In effect, inner cable 54 of Bowden cable 56 becomes a spring that helps ensure that parking brake 20 remains meshed with gear 26.

Accordingly, this invention is a much simpler and more cost effective solution than prior art designs for coupling the laterally pivotal control stick 14 to parking brake 20. It uses far fewer parts than prior art designs. It also totally obviates the need for a separate retention spring since inner cable 54 of Bowden cable 56 itself becomes the spring when parking brake 20 is engaged.

Various modifications of this invention will be apparent to those skilled in the art. Thus, the scope of the invention shall be limited only by the appended claims.

We claim:

1. An outdoor power equipment unit, which comprises:
a) a frame supported for movement over the ground by a plurality of wheels, at least one wheel being a drive wheel to propel the frame over the ground;
b) an implement carried on the frame for performing a ground or turf grooming or working operation;
c) a parking brake; and
d) a control selectively movable by an operator of the unit for engaging and disengaging the parking brake, wherein the control is operatively coupled to the parking brake by a flexible actuator cable, and wherein the actuator cable is arranged relative to the control and to the parking brake such that a portion of the actuator cable becomes additionally curved or bowed when the control is moved to engage the parking brake with the additional curvature or bow in the actuator cable being sufficient to exert a biasing force on the parking brake tending to keep the parking brake engaged.

2. The unit of claim 1, wherein the actuator cable is a Bowden cable having an inner cable that slides within an outer sheath.

3. The unit of claim 2, wherein the portion of the actuator cable that becomes additionally curved or bowed is a portion of the inner cable that extends between a fixed end of the outer sheath and the parking brake.

4. The unit of claim 3, wherein the control is movable on the frame of the unit and is coupled to the inner cable of the Bowden cable such that the control pushes the inner cable of the Bowden cable toward the parking brake to engage the parking brake, wherein pushing the inner cable of the Bowden cable towards the parking brake extends a greater length of the inner cable into the space between the fixed end of the outer sheath and the parking brake to thereby cause the additional curvature or bow in the inner cable that creates the biasing force.

5. The unit of claim 4, wherein the parking brake comprises a pivotal pawl that engages a gear or sprocket in a drive train to the drive wheel to lock up the drive train to prevent unintended rolling movement of the drive wheel.

6. An outdoor power equipment unit, which comprises:
a) a frame supported for movement over the ground by a plurality of wheels, at least one wheel being a drive wheel to propel the frame over the ground;
b) an implement carried on the frame for performing a ground or turf grooming or working operation;
c) a parking brake; and
d) a control selectively movable by an operator of the unit for engaging and disengaging the parking brake, wherein the control is pivotally carried on the frame of the unit for lateral movement relative to the unit between an inboard position located in front of an operator's seat and an outboard position located to one side of the operator's seat to permit the operator to mount and dismount the unit;
e) a linkage for coupling the control to the parking brake; and
f) a bevel gear arrangement for converting laterally outward pivoting of the control between the inboard and outboard positions thereof into longitudinal movement of at least a portion of the linkage relative to the frame to engage the parking brake.

7. The unit of claim 6, wherein the longitudinal movement causes the portion of the actuator cable to become additionally curved or bowed with the additional curvature or bow in the actuator cable being sufficient to exert a biasing force on the parking brake tending to keep the parking brake engaged.

8. The unit of claim 6, wherein the linkage comprises a flexible actuator cable.
